(19) United States
(12) Patent Application Publication
(10) Pub. No.: US 2011/0289187 A1
(43) Pub. Date: Nov. 24, 2011

(54) Method for Transmitting a Media File to a Mobile Device and Entity Therefor

(75) Inventors: Per-Erik Brodin, Sollentuna (SE); Stefan Alund, Enskede (SE)

(73) Assignee: TELEFONAKTIEBOLAGET L M ERICSSON (PUBL), Stockholm (SE)

(21) Appl. No.: 13/132,532

(22) PCT Filed: Dec. 4, 2008
(86) PCT No.: PCT/EP2008/066819

§ 371 Date: Aug. 16, 2011

(51) Int. Cl. G06F 15/16

(52) U.S. Cl. 709/217

(57) ABSTRACT

The invention relates to a method for pushing a transcoded media file to a mobile device, wherein a media file retrieved from a web page by a functionality added to said web page is automatically transmitted to a transcoding server where a media file format supported by the mobile device is automatically selected. The transcoded media file is then pushed to the mobile device.

### TECHNICAL FIELD

This invention relates to a method for transmitting a media file to a mobile device and to an entity for transmitting a transcoded media file to the mobile device.

### BACKGROUND

In the internet online content providers, such as YouTube, are known. Users can view content using a web browser on their computer or using external applications to extract a content from the web page, so that it can be viewed offline. The extraction procedure typically involves a manual step from the user. Once the piece of content has been extracted from the online side, users normally need to transcode the content into a suitable format before transferring and playing the content on a mobile device, such as an iPod or mobile phone.

Meanwhile the available storage space on mobile devices is constantly increasing, making it possible for users to carry more and more of their media files with them. The content of the media files can be consumed when users are on the move and there is no need to be connected to a network, since the content is locally stored on the mobile device.

Mobile devices that are connected to a network, by way of example a mobile phone connected to a cellular network, can receive content via push delivery mechanisms. Push content delivery is initiated from the server or content provider site instead of the user requesting the content.

Users that want to extract media files from an online content provider and transfer it for consumption on a mobile device, e.g. mobile phone, need to perform a number of manual steps which are cumbersome and sometimes difficult. Furthermore, different mobile devices have different content decoding capabilities. Users need to pay attention to the original source format as well as which media codecs and container formats are supported by the mobile device to which the media file should be transmitted.

Once the content has been transcoded into a desired format, it has to be transferred from e.g. a computer to the mobile device using for each a USB cable or a wireless connection, such as Bluetooth or WLAN. Therefore, a number of manual steps has to be performed.

### SUMMARY

Accordingly, a need exists to provide a possibility to facilitate the transfer of media files to a mobile device in the correct format.

This need is met by the features of the independent claims. In the dependent claims preferred embodiments of the invention are described.

According to a first aspect of the invention, a method for transmitting a media file to the mobile device is provided, wherein, upon selection of a media file, identification information of the selected media file is received, said identification information being retrieved from a web page by a functionality added to said web page that allows to analyze the web page and to determine said identification information. Furthermore, the selected media file is automatically downloaded to a media transcoding server. In an additional step the mobile device to which the media file is to be transmitted is identified and a media file format supported by the mobile device is automatically selected. With the media file format known the media file is automatically transcoded into the selected media file format and a download information concerning the transcoded media file is pushed to the mobile device. The invention provides a convenient way for users to push online content onto their mobile devices by drastically reducing the number of manual steps that need to be carried out by the user. Furthermore, the format supported by the mobile device is automatically selected.

According to a preferred embodiment of the invention it is additionally determined whether a push client is provided on the mobile device, wherein in the affirmative the download information of the pushing step contains the transcoded media file. If a push client is present on the mobile device, the method can further be automated, as it is possible to directly push the transcoded media file to the mobile device. In this embodiment an additional interaction of the user is not necessary. However, it may be the case that a push client is not provided on the mobile device. In this situation the download information of the pushing step may contain an address information from where the transcoded media file can be downloaded. By way of example a SMS may be sent to the mobile device containing an URL as address information where the transcoded media file is stored and from where it can be downloaded.

The media file can be transcoded into one media file format. However, it is also possible that it is transcoded into more than one media file formats. To maximize the user experience it is desirable that the best transcoding configuration possible for the mobile device is selected. This can be achieved in one embodiment by receiving the media file format from a configurable access server that is configurable by a user of the mobile device. By way of example a push gateway can be provided as a configuration frontend for the user to specify format information for the mobile device, the configuration frontend furthermore specifying a telephone number in case the mobile entity is a mobile phone to which the download information or the transcoded media file itself should be transmitted.

According to another embodiment of the invention the media file format may be selected by deducing the format into which the media file should be transcoded from a subscriber information in connection with which the mobile device is used in a mobile communication network. By way of example this could be achieved by querying a user subscription server for device information linked to the user. If no device information can be retrieved, a default codec configuration may be used.

Preferably, the step of receiving said identification information comprises the step of receiving a request requesting the download of the media file to the mobile device, the request containing said identification information.

The media file the user wants to download can be embedded in a web browser running on a computer. The functionality allowing to analyze the web page and to determine said identification information may be, by way of example, a bookmarklet, a bookmarklet being a small application stored as the URL of a boodmark in a web browser, the boodmarklet being designed to add one click functionality to a browser or web page. A bookmarklet is a short snippet of JavaScript code saved in a bookmark in the user's web page which upon invocation retrieves the identification information from the web page and sends a request to a media transcoding server that will download the selected media file and transcode it into the appropriate and desired format. It should be understood that any technology allowing to retrieve said identification information from the web page might be used.

According to another aspect of the invention an entity for transmitting a transcoded media file to the mobile device is provided comprising a receiver receiving identification information of the selected media file, said identification information being retrieved from a web page by the above discussed functionality, such as a bookmarklet. The receiver furthermore receives the selected media file that was selected from the website. An identification unit provided in the entity identifies the mobile device to which the media file is to be transmitted. A media file format selection unit automatically selects the media file format supported by the mobile device and a transcoding unit automatically transcodes the media file into the selected media file format. The entity furthermore comprises a push gateway pushing the download information of the transcoded media file to the mobile entity.

The push gateway may be adapted to be configured by the user of the mobile device so that the user is able to specify the desired media file format and/or specify the mobile device to which the transcoded media file should be transmitted. The media file format selection unit may query a user subscription unit for determining the media file format for the mobile device. If no media file format information can be found on the user subscription unit, a default codec configuration may be used.

### BRIEF DESCRIPTION OF THE DRAWINGS

The invention as well as preferred embodiments, further advantages and objectives will best be understood by reference to the following detailed description of an illustrative embodiment when read in conjunction with the accompanying drawings, wherein

FIG. 1 is a block diagram of an entity for transmitting a transcoded media file to a mobile device,

FIG. 2 is a flowchart showing the main steps for automatically transcoding and transmitting a media file to the mobile device, and

FIG. 3 shows another flowchart with the steps for pushing a transcoded media file to a mobile device.

### DETAILED DESCRIPTION

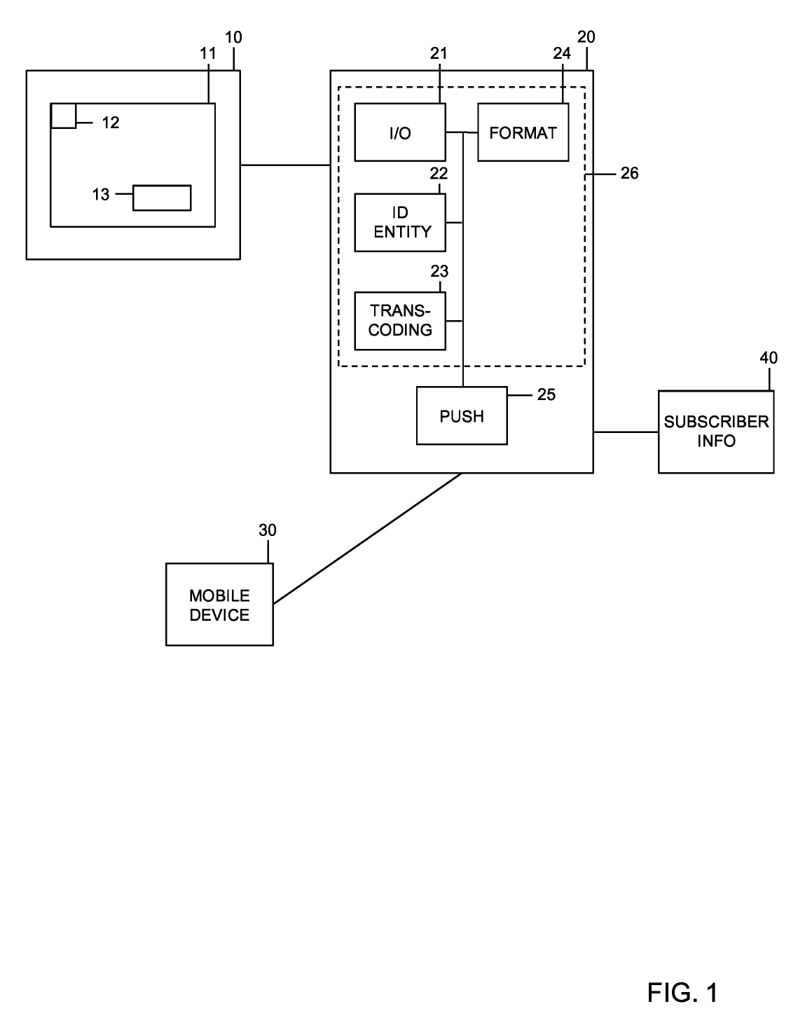

With reference now to the figures and in particular to FIG. 1 a block diagram of an entity is shown in which the present invention may be implemented. On a user computer 10 a website 11 is shown showing the content of an online content provider. Embedded in the web page 11 is a media file 13 that may be an audio file or a video file or a combination thereof. If the user of the computer 10 is interested in the media file 13, a bookmarklet (a snippet of JavaScript) 12 injected into the web page using several well-known techniques allowing to extend the website with new functionalities is activated. When the user then performs the applicable command, e.g. by pressing a predetermined combination of keys or a predetermined key on a keyboard of the computer 10, information about the media file is sent to an entity 20. The entity 20 comprises a media transcoding server 26 shown by the dashed lines in FIG. 1. The media transcoding server comprises an input/output unit 21 or receiver receiving the identification information of the selected media file, the media file itself, and receiving the request from the computer 10 to download the media file identified by the identification information. The media file itself may be downloaded from a media file database (not shown) connected to the web page where it is shown or the media file may also be received from the computer 10 to which it was downloaded upon invocation of the bookmarklet 12. The transcription server 26 additionally comprises an identification unit identifying the mobile device to which the media file should be transmitted. Furthermore, a media file format selection unit 24 is provided automatically selecting the media file format supported by the mobile entity. To this end, the media file format selection unit may access a user subscription unit 40 determining the file format for the mobile device. In another embodiment the media file format selection unit 24 may access a configuration frontend of a push gateway 25, where the user may have specified which format should be used for the media file. The entity 20 furthermore comprises the push gateway 25 mentioned above for pushing the download information of the transcoded media file to the mobile device 30. The transcoding unit 23 chooses the best codec configuration possible for the mobile entity. The transcoded media file is then transferred to the mobile device 30 using a push delivery mechanism. If a push client is installed on the target mobile entity it may be responsible for receiving the media file and presenting it to the user. This may involve producing a vibration, playing an alarm tone or any other means alerting the user of the new media file delivery. In the case where no push client is provided on the mobile entity, the user of the mobile entity might get a link to the transcoded version of the media file and the link may be transmitted for example in a SMS.

When the service is initiated on the web page 11, the user may choose not his own mobile device 30 but may instead send the media file to another known person, such as a friend. The alternative receiver may be specified for example by his/her MS IDSN or selected from a list of contacts provided by an external party or application, and the transcoding format may be selected by either accessing the user subscription unit 40 or the configurable frontend of the push gateway that was configured by the person to whom the media file is sent.

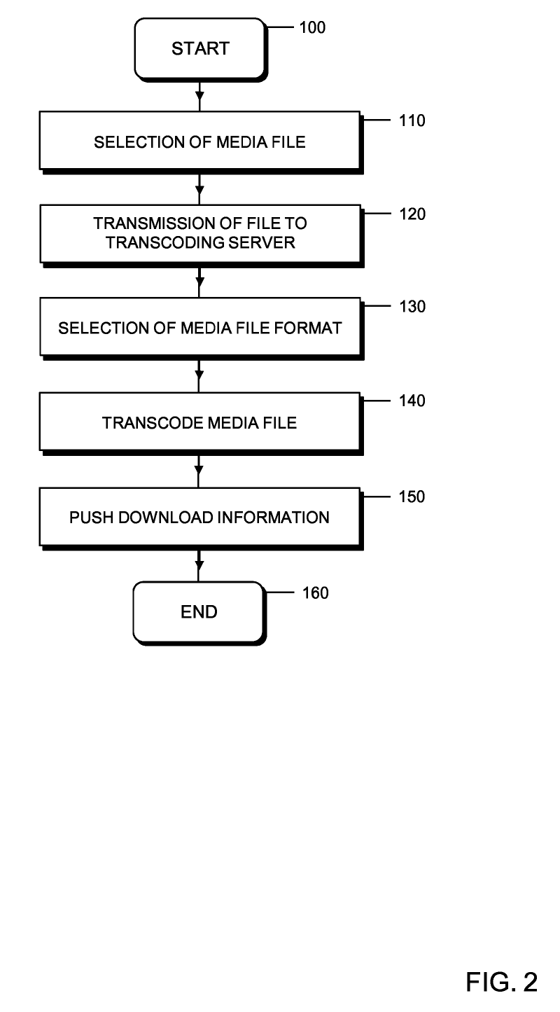

In FIG. 2 the main steps carried out with the system shown in FIG. 1 are shown in more detail. After starting the process in step 100, a media file is selected in step 110 by using the bookmarklet 12 or by using a functionality such as a greasemonkey user script, a greasemonkey being a browser extension enabling user scripts to be installed and run on third party websites in order to enhance them. Alternatively, a browser plug-in or extension may be installed on the web browser 11 providing the same functionality.

In step 120 the selected media file is transmitted to the transcoding server with the request that the media file identified by the identification information should be pushed to the mobile device. In step 130 a media file format is selected depending on the capabilities of the mobile device 30. In step 140 the media file is automatically transcoded into the format selected in step 130 and in step 150 the download information is pushed to the mobile device. The procedure ends in step 160. In the embodiment shown in FIG. 2 a user interaction is only needed in the selection of the media file and the activation of the functionality on the web page. The other steps 120-150 are carried out automatically resulting in an automated way for pushing the media file and for selecting the format supported by the mobile device.

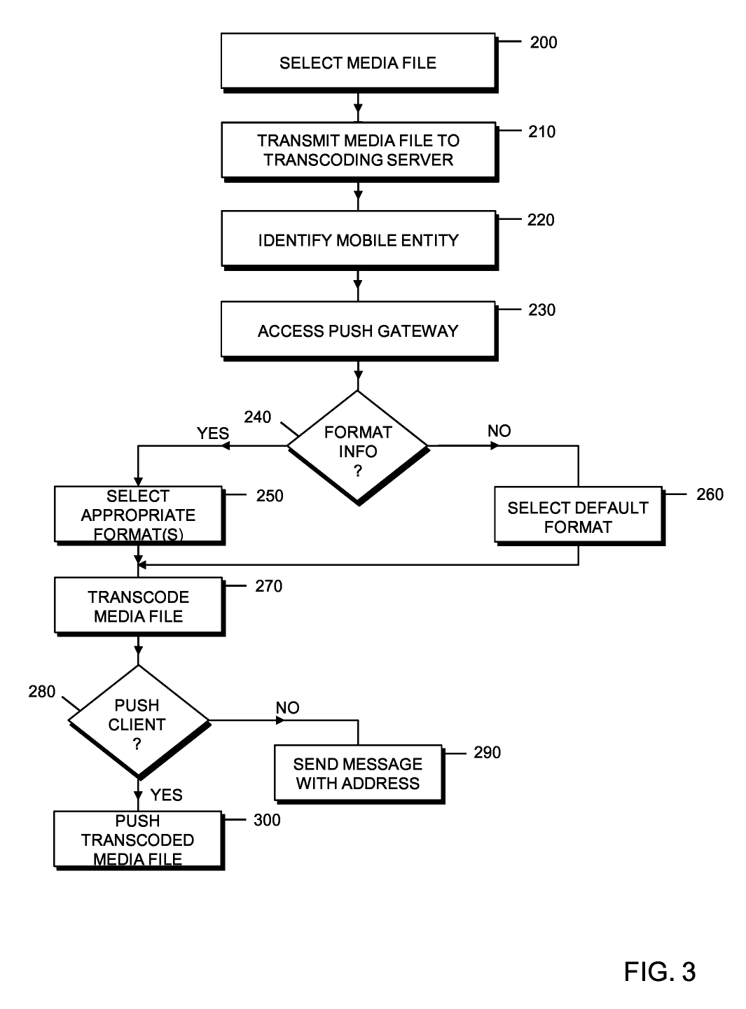

In FIG. 3 a flowchart with a more detailed description of the push mechanism is shown. After the selection of the media file in step 200, the media file is transmitted to the transcoding server in step 210 as it was already disclosed in connection with FIG. 2. In step 220 the mobile device is identified to which the media file should be transmitted and in step 230 a push gateway may be accessed in order to identify the format in which the media file should be transmitted to the mobile device. In step 240 it is asked whether a format information is provided in the push gateway. If this is not the case, a default format is selected in step 260. If format information can be found in step 240, on the push gateway 25 the appropriate format or formats are selected in step 250 and the media file is transcoded in step 270. Before the transcoded media file is directly pushed to the mobile device, it is asked in step 280 whether a push client is provided in the mobile device. By way of example, this information may be retrieved from the user subscription unit 40 or may be retrieved from the configuration frontend of the push gateway 25, where the user can specify the capabilities of the mobile device. If it is detected in step 280 that no push client is provided on the mobile device, the message may be sent to the mobile device including a download address information such as a URL from where the transcoded media file may be downloaded. If, however, it is detected in step 280 that a push client is present in the mobile device, the transcoded media file may be directly be pushed to the mobile device using the push gateway 25 (step 300).

Summarizing, the present invention provides an automated way for users to push a media file found on a website in the correct format to the mobile devices without requiring the installation of additional software.

1-10. (canceled)

11. A method implemented by a media transcoding server for transmitting a media file to a mobile device, comprising:
receiving identification information, which identifies a media file selected by a user of a web page, from functionality added to the web page that determines the identification information based on an analysis of the web page, wherein said functionality comprises at least one of a bookmarklet, a user script, and a Greasemonkey script,
automatically downloading the media file identified by the identification information received from said functionality,
identifying a mobile device to which the downloaded media file is to be transmitted,
automatically selecting a media file format supported by the mobile device,
automatically transcoding the downloaded media file into the selected media file format, and
pushing download information associated with the transcoded media file to the mobile device.

12. The method according to claim 11, further comprising determining whether a push client is provided on the mobile device, and wherein, if a push client is provided on the mobile device, the download information comprises the transcoded media file itself.

13. The method according to claim 11, further comprising determining whether a push client is provided on the mobile device, and wherein, if a push client is not provided on the mobile device, the download information comprises an address from which the transcoded media file can be downloaded.

14. The method according to claim 11, wherein said automatically transcoding comprises automatically transcoding the media file into more than one media file format.

15. The method according to claim 11, wherein automatically selecting the media file format comprises selecting the media file format based on format information received from an access server that is configurable by a user of the mobile device.

16. The method according to claim 11, wherein automatically selecting the media file format comprises deducing the media file format from subscriber information associated with the mobile device.

17. The method according to claim 11, wherein receiving said identification information comprises receiving a request that contains said identification information, wherein the request requests download of the media file to the mobile device.

18. A media transcoding server configured to transmit a transcoded media file to a mobile device, comprising:
a receiver configured to receive identification information, which identifies a media file selected by a user of a web page, from functionality added to the web page that determines the identification information based on an analysis of the web page, wherein said functionality comprises at least one of a bookmarklet, a user script, and a Greasemonkey script;
wherein the media transcoding server is configured to automatically download the media file identified by the identification information received from said functionality,
an identification unit configured to identify a mobile device to which the downloaded media file is to be transmitted,
a media file format selection unit configured to automatically select a media file format supported by the mobile device,
a transcoding unit configured to automatically transcode the downloaded media file into the selected media file format, and
a push gateway configured to push download information associated with the transcoded media file to the mobile device.

19. The media transcoding server according to claim 18, wherein the push gateway is configurable by a user of the mobile device in terms of at least one of information identifying the mobile device and information identifying the media file format.

20. The media transcoding server according to claim 18, wherein the media file format selection unit is configured to query a user subscription unit for determining the media file format for the mobile device.

21. The media transcoding server according to claim 18, configured to determine whether a push client is provided on the mobile device, and wherein, if a push client is provided on the mobile device, the download information comprises the transcoded media file itself.

22. The media transcoding server according to claim 18, configured to determine whether a push client is provided on the mobile device, and wherein, if a push client is not provided on the mobile device, the download information comprises an address from which the transcoded media file can be downloaded.

23. The media transcoding server according to claim 18, wherein said transcoding unit is configured to automatically transcode the media file into more than one media file format.

24. The media transcoding server according to claim 18, wherein the media file format selection unit is configured to select the media file format based on format information received from an access server that is configurable by a user of the mobile device.

25. The media transcoding server according to claim 18, wherein the media file format selection unit is configured to deduce the media file format from subscriber information associated with the mobile device.

26. The media transcoding server according to claim 18, wherein the receiver is configured to receive a request that contains said identification information, wherein the request requests download of the media file to the mobile device.
